(19) United States
(12) Patent Application Publication
(10) Pub. No.: US 2006/0290015 A1
(43) Pub. Date: Dec. 28, 2006

(54) HUMIDIFIER AND FLUID DISPENSING VALVE THEREFOR

(75) Inventors: Matthew A Williams, St. Louis, MO (US); Ryan Hale, St. Louis, MO (US); Douglas Schultz, St. Louis, MO (US)

Correspondence Address: LOCKE LIDDELL & SAPP LLP;ATTN. DOCKETING, 600 TRAVIS #3400, HOUSTON, TX, 77002, US

(73) Assignee: EMERSON ELECTRIC CO., St. Louis, MO (US)

(21) Appl. No.: 11/426,164

(22) Filed: Jun. 23, 2006

Related U.S. Application Data
(60) Provisional application No. 60/693,255, filed on Jun. 23, 2005.

(51) Int. Cl. B01F 3/04

(52) U.S. Cl. 261/66; 261/104; 261/107

(57) ABSTRACT

A humidifier system includes a water reservoir and a water bottle defining a discharge opening therein. A valve assembly has a sealing member that is positionable in closed and opened positions for selectively dispensing water through the discharge opening into the reservoir. The valve assembly further includes a locking feature to lock the sealing member in the opened position, preventing the valve from returning to the closed position until desired.

### CROSS-REFERENCE TO RELATED APPLICATION

This application is a nonprovisional application of U.S. Provisional Patent Application Ser. No. 60/693,255, filed on Jun. 23, 2005, which is incorporated by reference.

### BACKGROUND

The present invention relates generally to humidifiers, and more specifically, to a fluid dispensing valve for a humidifier bottle.

Humidifiers are well known and commonly used in households and businesses to add moisture to indoor air providing a more comfortable living environment. A comfortable level of humidity is generally 30-50% in the winter and 40-50% in the summer. If the humidity level is lower, atopic dermatitis, excessive static electricity, drying out of furniture and other various concerns may occur. A humidifier's many advantages include: alleviating a cold sufferer's sore throat, reducing any difficulty in breathing, and generally improving the health and comfort of the user's home.

Several varieties of humidifiers exist, differing in both humidification methods, size and refilling. The method of humidification varies from evaporative, ultrasonic, cool mist impeller, steam vaporizers and warm mist humidifiers. The present invention is directed to an evaporative humidifier, which is often called a “wicking” humidifier because is employs a large “wick” or filter. The filter draws water upward from a water reservoir base through capillary action. A fan blows air across or through the filter thereby diffusing moisture throughout the room.

Refilling a humidifier generally varies between a bottle fill design and a bucket fill design. Bottle fill designs have removable bottles for supplying the humidification humidifier with water. This enables the user to transport the bottle individually to the nearest sink for refilling. The reasonable size of the bottle and its removability from the humidifier make it easy to transport and causes little mess.

Humidifier water bottles typically include a valve through which water flows into the humidifier's water reservoir. Discharge valve assemblies typically perform at least two functions: (1) when the water bottle is to be removed from the humidifier, the discharge valve assembly should shut off water flow from the water bottle to prevent spilling when the bottle is transported; and (2) when the water bottle is to be seated in the humidifier, the discharge valve assembly should provide a fluid flow path so that the water inside the water bottle may flow though the path into the humidifying mechanism.

Discharge valve assemblies such as those described above can be complicated and often require multiple components. The requirement for multiple components may lead to procurement difficulties and high cost for the parts. The complex process of assembling can also result in higher manufacturing cost of the valve assembly.

Moreover, with known discharge valve assemblies, the discharge valve is contained in a removable cap, or a refill opening covered by a removable cap is provided separate from the discharge valve. To refill the bottle, the cap must removed to allow access to the bottle's refill opening. This adds complexity to the task of filling the bottle, and can result in losing the cap required to seal the refill opening.

The present disclosure addresses shortcomings of the prior art.

### SUMMARY OF THE INVENTION

In accordance with teachings of the present disclosure, a valve assembly for releasing fluid from a container, such as water from a humidifier bottle is disclosed. For example, a humidifier system includes a water reservoir and a water bottle defining a discharge opening therein. A valve assembly has a sealing member that is positionable in closed and opened positions for selectively dispensing water through the discharge opening into the reservoir. The valve assembly further includes a locking feature to lock the sealing member in the opened position, preventing the valve from returning to the closed position until desired.

### BRIEF DESCRIPTION OF THE DRAWINGS

Other objects and advantages of the invention will become apparent upon reading the following detailed description and upon reference to the drawings in which:

FIG. 1 is a schematic illustration of an exemplary bottle fill humidifier in accordance with certain teachings of the present disclosure.

FIG. 2 is a perspective view of an exemplary water bottle.

FIGS. 3 and 4 illustrate a discharge valve of the bottle shown in FIG. 2.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

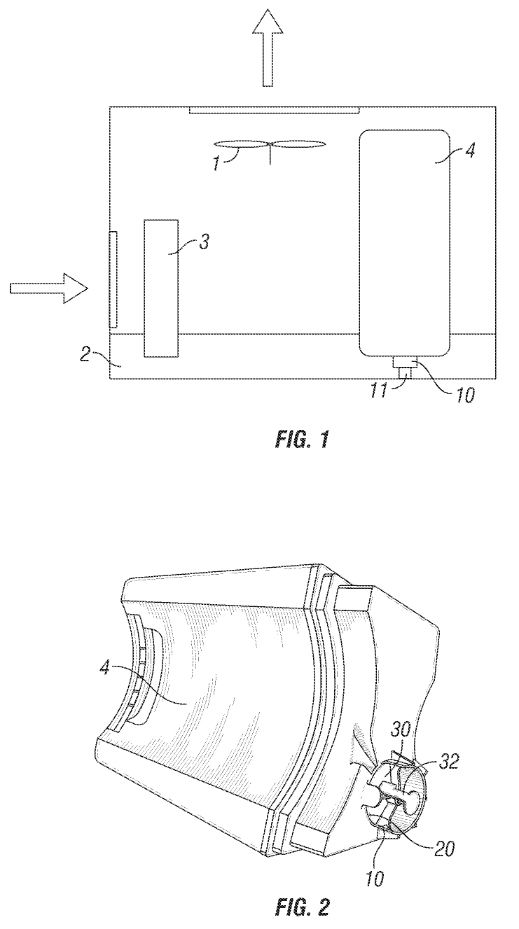

FIG. 1 conceptually shows an exemplary humidifier in accordance with certain teachings of the present disclosure. The humidifier includes a fan 1, a water reservoir 2 and a wick 3 partially disposed within the water reservoir 2. Water is discharged from a water bottle 4 into the water reservoir 2. The wick 3 absorbs water from the water reservoir 2 and, in turn, supplies moisture to the air stream propelled through the mechanism by the fan 1. The water bottle 4 may be removed from the humidifier periodically or as needed for refilling, cleaning or other purposes.

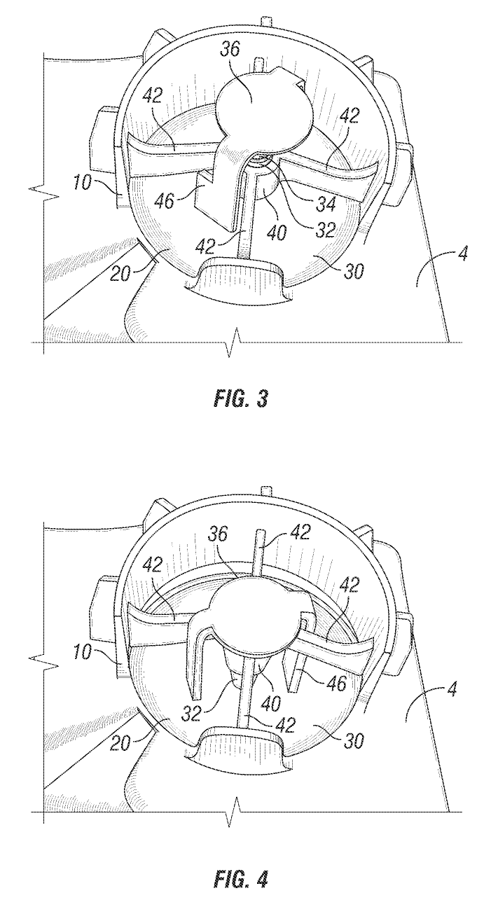

The water bottle 4 includes a valve assembly 10 for discharging water into the humidifying mechanism. FIG. 2 shows an exemplary water bottle 4 including the valve assembly 10 for selectively discharging water into the water reservoir 2. FIGS. 3 and 4 are close-up views of the bottle 4, illustrating portions of the water bottle 4, including the valve assembly 10, in further detail. The water bottle 4 defines a discharge opening 20 in the bottom thereof The valve assembly 10 includes a sealing member 30, a valve stem 32 and a biasing member 34. In the illustrated embodiment, the biasing member 34 is a spring situated about the valve stem 32.

A stationary cylinder 40 is fixed in place by rib members 42 extending from the cylinder 40 and connected to the water bottle 4 at the outer periphery of the discharge opening 20. The valve stem 32 extends through the stationary cylinder 40 such that it is movable axially relative to the cylinder 40 and also rotatable. The valve stem 32 has an actuator 36 attached to one end thereof, and the opposite end is attached to the sealing member 30. The biasing member 34 has one end received in the cylinder 40 and held in place therein such that, in the illustrated embodiment, the biasing member 34 pushes against the underside of the actuator 36 to position the sealing member 30 in a normally closed position. FIG. 2 shows the valve assembly 10 in the closed position.

To move the sealing member 30 to the open position, as illustrated in FIG. 3, the actuator 36 is depressed to move the valve stem 32 axially, pushing the sealing member 30 into the bottle 4 to allow flow through the opening 20. A catch 46 extends from the actuator 36. To lock the valve assembly 10 in the open position, after the actuator 36 has been depressed to unseat the sealing member 30, the actuator is rotated until the catch 46 engages one of the rib members 42. With the sealing member 30 locked in the open position, a user can easily fill the bottle through the discharge opening, eliminating the need for a removable cap.

To release the catch, the actuator 36 is again depressed and rotated so that the catch 46 is free of the rib member 42, then released allowing the biasing member 34 to return the valve stem 32 and sealing member 30 to the closed position. In the illustrated embodiment, the biasing member 34 applies a torsional force to the valve stem 32 so that when the actuator 36 is depressed, the valve stem 32 “automatically” rotates to release the catch 46, allowing the valve stem 32 to move axially and return the sealing member 30 to the closed position.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A humidifier comprising:
a water reservoir;
a wick receivable by the water reservoir;
a water bottle defining a discharge opening therein; and
a valve assembly including:
a sealing member positionable in closed and opened positions for selectively opening and closing the discharge opening,
a stationary member fixed relative to the discharge opening;
a valve stem received by the stationary member such that the valve stem is movable relative to the stationary member to selectively position the sealing member in the closed or open position; and
a catch member connected to the valve stem, the catch member cooperating with the stationary member to lock the sealing member in the open position.

2. The humidifier of claim 1, further comprising a biasing member situating the sealing member in a normally closed position.

3. The humidifier of claim 1, further comprising an actuator connected to one end of the valve stem, wherein the catch member is connected to the actuator.

4. The humidifier of claim 1, wherein the stationary member includes a cylinder having a plurality of rib members extending therefrom and connected to the water bottle adjacent the discharge opening.

5. The humidifier of claim 4, wherein the valve stem is received by the cylinder, such that the valve stem is movable axially and rotatably relative to the cylinder.

6. The humidifier of claim 5, wherein the catch engages one of the ribs when the valve stem is rotated.

7. The humidifier of claim 6, further comprising a biasing member situated between the stationary member and the actuator to situate the sealing member in a normally closed position, the biasing member further applying a torsional force to the actuator such that the biasing member rotates the valve stem to release the catch in response to the actuator being depressed.

8. A valve assembly for selectively dispensing fluid through a discharge opening of a container, the valve assembly comprising:
a sealing member;
a stationary member fixed relative to the discharge opening;
a valve stem received by the stationary member such that the valve stem is movable relative to the stationary member to selectively position the sealing member in a closed position or an open position; and
a catch member connected to the valve stem, the catch member cooperating with the stationary member to lock the sealing member in the open position.

9. The valve assembly of claim 8, further comprising a biasing member situating the sealing member in a normally closed position.

10. The valve assembly of claim 8, further comprising an actuator connected to one end of the valve stem, wherein the catch member is connected to the actuator.

11. The valve assembly of claim 8, wherein the stationary member includes a cylinder having a plurality of rib members extending therefrom and connectable to the container adjacent the discharge opening.

12. The valve assembly of claim 11, wherein the valve stem is received by the cylinder, such that the valve stem is movable axially and rotatably relative to the cylinder.

13. The valve assembly of claim 12, wherein the catch engages one of the ribs when the valve stem is rotated.

14. The valve assembly of claim 13, further comprising a biasing member situated between the stationary member and the actuator to situate the sealing member in a normally closed position, the biasing member further applying a torsional force to the actuator such that the biasing member rotates the valve stem to release the catch in response to the actuator being depressed.

15. A method of filling a humidifier bottle having a discharge opening, the method comprising:
moving a valve stem that is connected to a sealing member to move the sealing member from a closed position to an opened position; and
rotating the valve stem until a catch engages a stationary member connected to the bottle to lock the sealing member in the opened position; and
filling the bottle through the discharge opening.

16. The method of claim 15, wherein moving the valve stem includes depressing an actuator connected to the valve stem and the sealing member.

17. The method of claim 16, wherein rotating the valve stem includes rotating the actuator in a first direction until the catch engages the stationary member.

18. The method of claim 17, further comprising:
providing a biasing member to apply a torsional force to the valve stem in a second direction opposite the first direction; and
depressing the actuator, allowing the biasing member to rotate the valve stem in the second direction and release the catch and return the sealing member to the closed position.
